(19) United States
(12) Patent Application Publication
(10) Pub. No.: US 2012/0150956 A1
(43) Pub. Date: Jun. 14, 2012

(54) Extended Video Conferencing Features Through Electronic Calendaring

(75) Inventors: Michael Robert Tucker, Austin, TX (US); Stephen Paul Schaefer, Cedar Park, TX (US); Alain Nimri, Austin, TX (US)

(73) Assignee: POLYCOM, INC., Pleasanton, CA (US)

(21) Appl. No.: 12/965,105

(22) Filed: Dec. 10, 2010

(51) Int. Cl. G06F 15/16

(52) U.S. Cl. 709/204

(57) ABSTRACT

Systems and methods to integrate or interface video conference rooms, video conference infrastructure equipment and electronic calendars are disclosed. Example embodiments include providing: security for meeting information; interfaces for personal electronic calendar applications and video conferencing equipment; and implementations for video conferencing infrastructure components to integrate with meeting scheduling software. Also disclosed are systems and methods for making information automatically available via interfaces to the scheduling software (e.g., via a plug-in or extension to the regular interface software and integration modules executing in video conferencing infrastructure equipment) without a change in how a user interacts with existing meeting scheduling software.

### CROSS-REFERENCE TO RELATED APPLICATIONS

This disclosure claims priority to U.S. Provisional Patent Application Ser. No. 61/298,604 entitled “Extended Video Conferencing Features through Electronic Calendaring” filed 27 Jan. 2010 by Michael Tucker et al., which is hereby incorporated by reference in its entirety. This disclosure is also related to subject matter disclosed in U.S. patent application Ser. No. 12/542,331, entitled “Archiving Content in a Calendared Event,” filed 17 Aug. 2009 by Stephen Schaefer et al., which is hereby incorporated by reference in its entirety.

### FIELD OF THE DISCLOSURE

This disclosure relates generally to the field of video conferencing. More particularly, but not by way of limitation, this disclosure relates to a method of providing an interface between a meeting scheduling system and equipment utilized to facilitate the meeting whereby scheduling of a video conference, initiation of a video conference, and content shared before, during, or after a video conference may be automatically integrated with a meeting scheduling system (e.g., calendaring software application).

### BACKGROUND

In today's corporate environment, it is typical to schedule meetings via meeting scheduling software. The meeting scheduling software sends a message to “meeting invitees” and usually allows for automatic creation of a calendar entry in the invited participants personal electronic calendar. Examples of meeting scheduling software include MobileMe available from Apple Inc., Cupertino, California (MobileMe is a registered trademark of Apple Inc.); Google Calendaring available from Google, Inc., Mountain View, Calif.; Lotus Notes available from IBM corporation, Armonk, N.Y.; Mozilla Sunbird available from Mozilla Corporation, Mountain View, Calif.; and Microsoft Outlook/Exchange available from Microsoft Corporation, Redmond, Wash.

Presently, scheduling and initiation of a video meeting may require a potential user to understand more about the technology and infrastructure equipment used in video conferencing than is strictly necessary. For example, some types of equipment run different signaling protocols and can have different dialing methods. Additionally, connection addresses for video conference equipment may not be standardized. Capacity capabilities of bridging equipment at times in the future should be taken into account when scheduling meetings (e.g., capacity at future meeting times). Furthermore, security of information describing a meeting may be important to a person scheduling a meeting. Because of these complexity issues and others the use of video collaboration tools may take too much time and energy on the part of a meeting organizer.

To overcome these and other shortcomings, a system and method to integrate or interface video conference rooms, video conference infrastructure equipment and personal electronic calendars is needed. Example embodiments disclosed herein include a method and system to provide: security for meeting information; interfaces for personal electronic calendar applications and video conferencing equipment; and implementations for video conferencing infrastructure components to integrate with meeting scheduling software. It would also be desirable for this information to be automatically made available via interfaces to the scheduling software (e.g., via a plug-in or extension to the regular interface software and integration modules in video conferencing infrastructure equipment) without a change in how a user interacts with existing meeting scheduling software.

### SUMMARY

In one embodiment, a conferencing device is configured with a programmable control device. The programmable control device can be programmed to receive indications of calendar events and data associated with the calendar event. Upon receipt of the scheduling information the programmable control device may cause infrastructure components necessary to facilitate a video conference to signal other infrastructure components to: initiate a conference, determine infrastructure requirements to support a conference, or perform capacity planning and allocation of conferencing equipment. At meeting initiation, call signaling infrastructures, which possibly run different signaling protocols (e.g., H.323, H.320, or Session Initiation Protocol (SIP)), may route calls with the same address to a common video conferencing bridge. Also, video bridges which are capable of mixing endpoints of the type invited into a meeting and available based on capacity may be selected to facilitate the video conference.

In another embodiment, a meeting organizer may have the capability to schedule a private meeting and invite public resources while concealing at least some of the private information pertaining to the video conference. For example, when a meeting organizer schedules a meeting, a public resource (e.g., physical conference room) may need to be allocated to facilitate the meeting. This allocation is typically implemented by providing a “meeting invitation” to the public resource. Because the public resource receives the meeting invitation the public resource interface may have access to details about a meeting that should not be disclosed to the public. Therefore, this embodiment allows a user to specify that certain information is not to be displayed at the public resource or made available to uninvited users who query the public resource for information.

In another embodiment, a method of maintaining meeting content is disclosed. A meeting scheduler (i.e., organizer) creates a meeting entry in meeting scheduling software. The organizer invites meeting participants and those able to attend, conduct a meeting or a conference. Any content recorded during the meeting can be associated to the original meeting invite automatically such that meeting participants and unavailable invitees can have access to the meeting content via the original calendar entry created in the meeting scheduling software.

### BRIEF DESCRIPTION OF THE DRAWINGS

FIG. 1 illustrates, in block diagram form, an example network of supporting equipment for one embodiment of this disclosure.

FIG. 2 illustrates, in flowchart form, a process for scheduling, collecting, and initiating a conference according to one embodiment disclosed herein.

FIG. 3 shows a screen shot of a representation of a work week view of a user's electronic calendar.

FIG. 4 illustrates, in block diagram form, an architecture hierarchy according to one disclosed embodiment.

FIG. 5 illustrates, in flowchart form, one embodiment for clients monitoring a calendaring system with a “pull subscription.”

FIG. 6 illustrates, in flowchart form, one embodiment for clients determining when a meeting is about to begin and automatically taking an appropriate action.

FIG. 7 illustrates a potential timeline of activity performed by users and automated devices according to one disclosed embodiment.

FIGS. 8A-B show two potential implementations of notifications to an end user based on the current status of the end user equipment at the time of notification.

FIGS. 9A-G show screen shots of “private” meeting information availability and suppression according to one disclosed embodiment.

FIG. 10 illustrates, in block diagram form, an example conferencing device comprising a programmable control device.

### DETAILED DESCRIPTION

Systems and methods to integrate or interface video conference rooms, video conference infrastructure equipment and personal electronic calendars are disclosed. Example embodiments include providing: security for meeting information; interfaces for personal electronic calendar applications, video conferencing equipment, and other shared resources; and implementations for video conferencing infrastructure components to integrate with meeting scheduling software. Also disclosed are systems and methods for making information automatically available via interfaces to the scheduling software (e.g., via a plug-in or extension to the regular interface software and integration modules in video conferencing infrastructure equipment) without a change in how a user interacts with existing meeting scheduling software. Although the methods and systems disclosed herein may at times refer to the Microsoft Outlook client and the Microsoft Exchange server, one of ordinary skill in the art, given the benefit of this disclosure, will recognize the inventive concepts disclosed herein are applicable to different calendaring and scheduling software implementations. Types of conferences include but are not limited to video conferences, web conferences, white board conferences, audio only conferences and, a mixture of types of conferences, among others. Throughout this disclosure, references to Outlook and Exchange specifically are simply examples of one implementation of a calendaring system client and calendaring system server respectively.

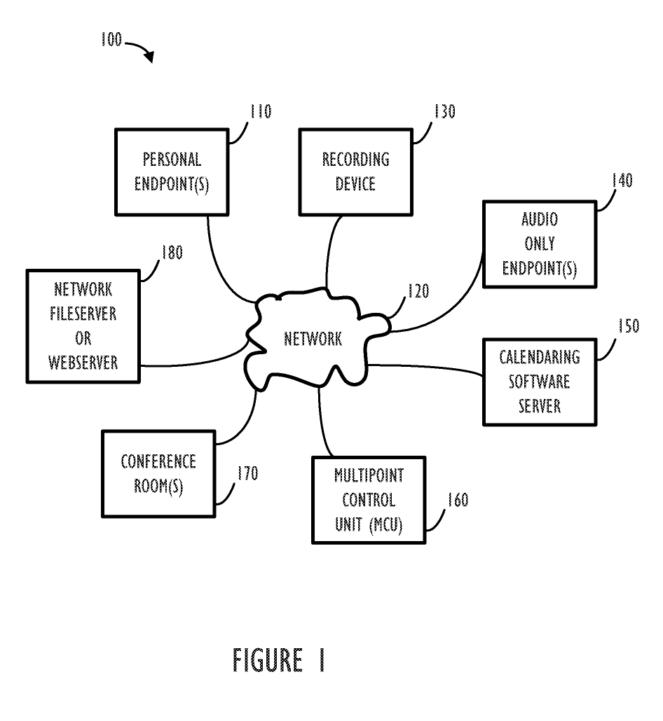

FIG. 1 shows, in block diagram form, example equipment 100 available to a corporation for facilitating a meeting. The meeting may take place at a single location or between multiple locations with potentially differing numbers of participants at the different locations. When participants of a meeting are not all at one location, a conference can be initiated to connect the multiple locations. A conference may be an audio only conference, a video conference, a data conference or a combination thereof. In one type of hybrid conference some locations can have full audio and video while other locations may be limited to audio only or be able to receive video and only supply audio (e.g., video from a computer over a network and audio via a telephone).

As shown in FIG. 1, each of the different types of equipment available to support a meeting can be communicatively coupled via network 120. Network 120 represents multiple network types and network technologies known to those of skill in the art (e.g., POTS, Ethernet, TCP/IP, packet switched, circuit switched, cellular, LAN and WAN). Each of the different types of equipment shown in FIG. 1 represents a logical capability and each of these logical capabilities may be combined and provided by a single physical device. Also, each of the different types of equipment may or may not include a programmable control device capable of being programmed to provide extended capabilities to the equipment via software, middleware or firmware, etc. Additionally, each type of equipment may be enabled to interface with the calendaring server 150 via a client application executing on the device or otherwise.

FIG. 1 shows a personal endpoint 110. Each of a potential plurality of personal endpoints 110 may include a personal conferencing system or optionally a camera input device connected to a personal computer. A single personal endpoint 110 may be used by a single participant of a conference or in some cases may support a small number of people. A personal computer acting as a personal endpoint 110 can include a processor that has been specifically programmed with software allowing it to connect to and participate in a conference. One example of such software is the CMA Desktop Video Soft Client available from Polycom Inc., Pleasanton, Calif.

FIG. 1 also shows a recording device 130 communicatively coupled to network 120. Recording device 130 can allow for recording the audio portion of the conference or the audio and video portion of the conference. Recording device 130 can be configured to record the data from selected video capture devices (e.g., camera) or all video capture devices supporting a conference. Recording device 130 may further contain a programmable control device programmed to interface recording device 130 with other devices connected to network 120. In particular, recording device 130 may be programmed to provide information and recorded content to network fileserver or webserver 180 and/or calendaring software server 150. Furthermore, recording device 130 may be integrated into the same physical device providing other logical capabilities shown in FIG. 1. Examples of recording device 130 include the recording and streaming server RSS™ 2000 and the Polycom Video Media Center (VMC) 1000 each available from Polycom, Inc., Pleasanton, Calif. (RSS is a registered trademark of Polycom, Inc.).

Next, FIG. 1 shows an audio only endpoint 140 communicatively coupled to network 120. Audio only endpoint(s) 140 represent endpoints where a conference participant may have limited conferencing network devices. For example, a participant may be connected to the conference via a cellular phone because they are traveling or may only be able to connect to the conference via a traditional land line telephone. In other instances, a conference participant may be equipped with both an audio only endpoint 140 and a personal computer acting as a personal endpoint 110, which can view meeting content. However, in this example the personal computer acting as a personal endpoint 110 is not configured to receive or provide audio. Therefore, the combination of personal endpoint 110 and audio only endpoint 140 work together for a conference participant.

Calendaring software server 150 is an example server to support one implementation of meeting scheduling software. Calendaring software server 150 is communicatively coupled to network 120. Calendaring software server 150 can be configured to support a meeting scheduling client application (e.g., Microsoft Outlook (not shown)) providing a calendar type interface to end users. End users of a network in a corporate environment are typically a superset of the users invited to a meeting (i.e., meeting invitees) and potentially become conference participants. As used herein, “meeting invitees,” includes all of the people and resources (e.g., conference rooms, conferencing equipment, etc.) receiving an invitation to the meeting. In some cases, these people will be selected by the meeting organizer while in other cases original invitees may forward the meeting invite to additional people.

Multipoint Control Unit (MCU) 160 is also communicatively coupled to network 120. Multipoint audio and/or multimedia calls are typically scheduled in advance through companies that own MCUs or audio bridges. An MCU 160 can provide the capability for two or more terminals to participate in a multipoint audio and/or multimedia conference. Additionally, an MCU 160 can host Virtual Meeting Rooms (VMRs) to support a multimedia conference. An audio bridge can provide the capability for two or more terminals to participate in a multipoint audio conference. In this disclosure the term MCU may also refer to an audio bridge used for multipoint audio conferences; therefore, in the description words such as MCU and audio bridge may have the same meaning A terminal is an end-point on a network, capable of real-time, two-way audio, data and/or visual communication with other terminals or an MCU 160. The information communicated between the terminals and/or the MCU 160 includes control signals, indicators, audio, moving color video, pictures and/or data. A terminal may provide speech only, speech and data, speech and video, or speech, data and video. One or more MCUs 160 may be configured to support a conference. One example of an MCU 160 is the RMX2000 provided by Polycom Inc., Pleasanton, Calif.

One or more conference rooms 170 may also be utilized during a conference. These conference rooms 170 may be physical conference rooms where meeting participants are physically present and in the proximity of cameras, microphones or other conference supporting equipment. Additionally, conference rooms 170 may be virtual conference rooms (e.g., VMRs hosted on an MCU bridge) where participants are not physically located but are logically grouped such that they appear to other participants as if they were in the same conference room. In each implementation of conference room 170 there can be one or more devices communicatively coupled to network 120.

Network file server or webserver 180 represents a server configured to store and share meeting content. In one embodiment, meeting content may be stored on the calendaring software server 150. In another preferred embodiment, calendaring software server 150 is not utilized to store actual content from the meeting but instead stores a link (e.g., Universal Resource Locator, URL) pointing to a storage server (e.g., network fileserver or web server 180). In this preferred embodiment the calendaring software server 150 is off loaded of the responsibility for storing possibly voluminous meeting content and allowed to support its primary function of calendaring software support.

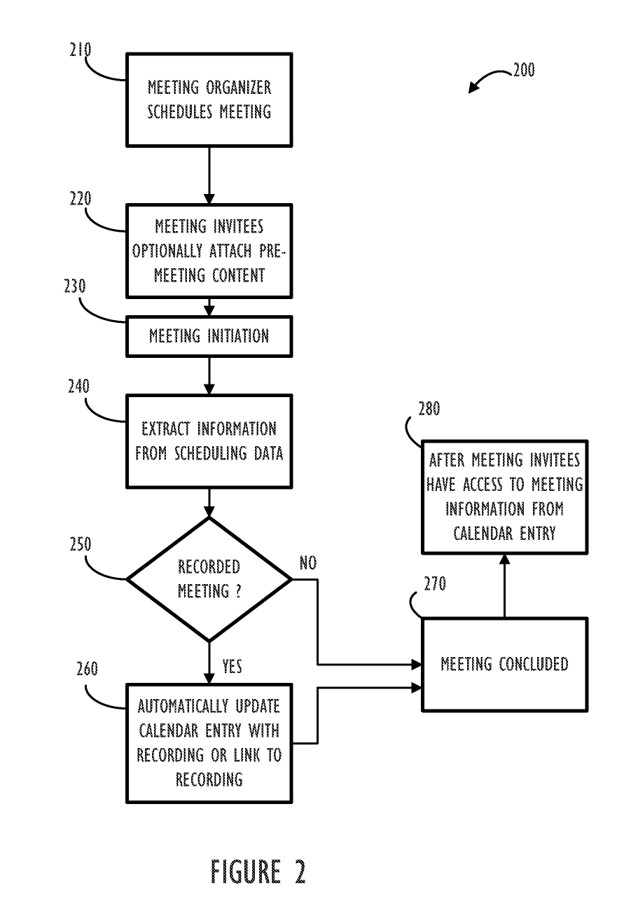

Referring now to FIG. 2, process 200 shows a possible work flow for scheduling and conducting a meeting or a conference. First, at block 210 a meeting organizer schedules a meeting via meeting scheduling software. When the meeting organizer decides to organize a meeting which includes a number of human participants, he may use his Outlook client to organize the meeting by inviting participants. In one embodiment, the Outlook client may have extended capabilities (like those disclosed herein) via an add-in or plug-in component. During the process of creating the meeting invitation, the organizer may decide to include video conferencing in the meeting and provide dialing or connection information within the meeting information. The organizer may also decide to include one or more physical conference rooms in the invitation. The organizer may also be presented an option to record the meeting if recording capabilities are present and available to facilitate the meeting. Finally, the organizer may decide to mark some or all of the meeting information “private” so that the private information will not be available to the general public from shared resources invited to the meeting.

After organizing the meeting, the organizer indicates a desire to send the invitation to all meeting invitees. Prior to being actually sent, the Outlook client being used by the organizer may collect or cause to be collected information that can be automatically included in the meeting invitation. The automatically included information may include information enabling participants to manually connect to the meeting if required (e.g., participants away from the office). After meeting invitations are actually sent, the organizer is able to receive accept/decline responses from all human participants, and possibly the conference room(s), virtual meeting rooms (VMR) on a video bridge, recording system, or other infrastructure resources. If necessary, the organizer can change the time or location of the meeting and send updates.

Next, at block 220 meeting invitees may optionally attach pre-meeting content to the calendar entry and thus provide easy access to this content either before or during the meeting. Pre-meeting content may include slide presentations, other office documents, meeting agenda, pre-recorded multimedia, and meeting preparation materials. At the scheduled time of the meeting, block 230, the meeting is initiated. As part of the initiation process, one or more programmable control devices communicatively coupled to the meeting scheduling software may retrieve information (block 240) from the meeting invitation and automatically dial into the video conference. Information retrieved may include dialing information, supported protocols, preferred equipment with scheduled capacity, etc. This information can be retrieved by infrastructure communicatively coupled to the scheduling software system. For example, an Exchange client program may be executing on a video system or a plug-in may be running on a PC configured as a video client. Also, end users and infrastructure resources such as physical conference rooms may be automatically connected or prompted with a confirmation message prior to joining the conference. If certain invited participants are outside the office, the participant can read connection information available in the meeting invitation and connect to the meeting via whatever means available at their current location. Invitations may also include calling links whereby invitees may join a conference by simply activating the link.

After initiation is complete, an optional message may be presented to the meeting organizer or to all participants. This optional message could, for example, disclose resources scheduled for the meeting but not currently in-use and people that were scheduled for the meeting but not currently present (i.e., not connected). Based on this information, the organizer may or may not decide to conduct the meeting with the available participants and resources. At block 250, it is determined if the meeting content (e.g., audio and/or video) should be recorded. If so, the YES prong of block 250, flow continues to block 260 where the calendar entry may be automatically updated with a copy of the recorded information or a link to the recorded information. Those of skill in the art will recognize that links may include but are not limited to, hyperlinks, icons or thumbnail representations indicating content corresponding to the meeting. If the meeting content was not recorded, the NO prong of block 250, flow continues directly to block 270. At block 270 the meeting has concluded and if necessary meeting invitees are notified that meeting materials are available. Flow then continues to block 280 where meeting participants may review the meeting information or unavailable meeting invitees (i.e., invitees that were not able to attend the actual meeting) can review meeting materials and replay any recorded content from the conference. A review of meeting materials may take place from several different types of devices, including but not limited to, individual computer workstations or other video conferencing devices equipped with an interface to the calendar scheduling software or an interface to email software.

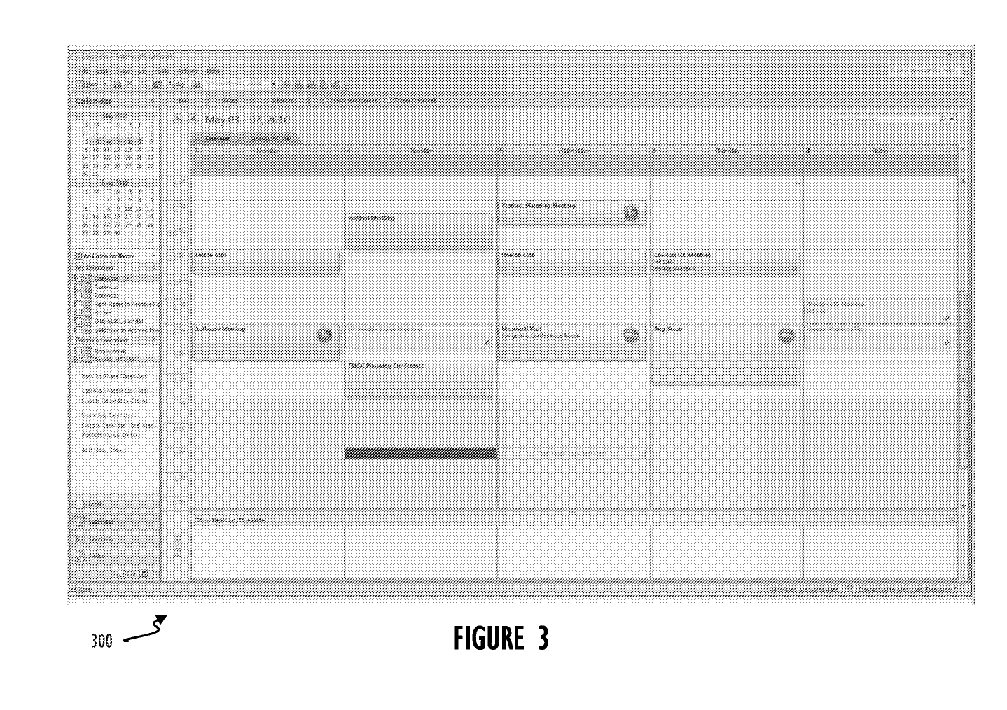

Referring now to FIG. 3, screen shot 300 shows an example of a screen shot of a user interface view of multiple calendar entries maintained in a user's electronic calendar. Screen shot 300 shows a “week-view” of a user's scheduled meetings.

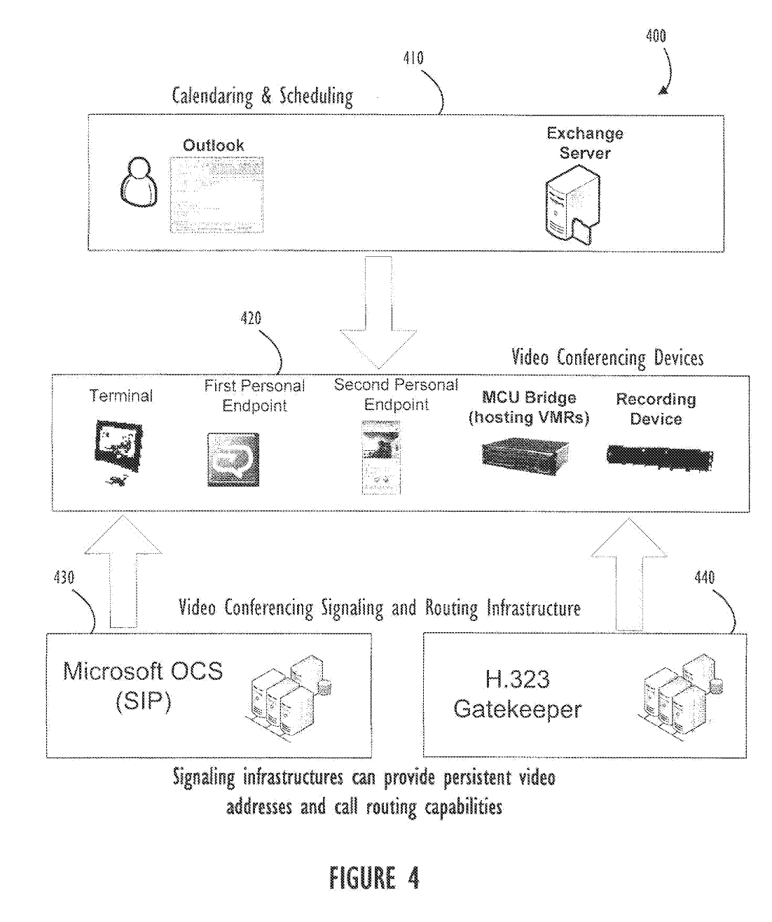

Referring now to FIG. 4, illustrating a block diagram 400 of an embodiment of a system architecture comprising three levels representing one embodiment of this disclosure. The lowest layer (430 and 440) represents the signaling and call routing infrastructure. Examples include: Microsoft OCS (430) and H.323 (440). There can be multiple, independent call signaling layers running different protocols within a single video conferencing deployment. This layer provides two functions within this embodiment: 1) to provide persistent, long-lived video addresses for the video conferencing devices and 2) to reliably route video conference calls for devices utilizing the persistent long-lived addresses. Note that the address used in this embodiment is typically routed to the same VMR in each signaling infrastructure. In addition, the bridge equipment hosting the VMR may be capable of mixing equipment connecting with different protocols into the same conference.

The middle layer (420) represents video conferencing devices. Endpoint devices can be registered to a call signaling server in the signaling and routing infrastructure. Again, multiple call routing infrastructures, running different protocols, may be present. Video bridge devices may be capable of having calls routed to them within each infrastructure. For example, the bridge may have a pool of video numbers (i.e., Virtual Meeting Rooms or VMRs) and each signaling infrastructure can be configured to route any calls destined for one of these numbers to the bridge.

The top layer (410) represents the scheduling/calendaring layer. For example, the top layer may consist of one or more Exchange Servers and Outlook clients operating within an organization which enable meeting organizers and participants to organize meetings and view/manage their calendars. Video conferencing devices which are part of the Video Calendaring enterprise may interact with this layer. One goal of this embodiment is to make it easier for meeting organizers and participants to schedule and use video conferencing in their meetings.

Each call signaling infrastructure (e.g., SIP and H.323) should be capable of routing calls dialed with the same address (e.g., 75333) to the same virtual meeting room (VMR). In addition, each video conferencing device should be capable of properly formatting the address and dialing it in the infrastructure to which that video conferencing device is connected. In the following example, numerical addresses are used, but URI addresses could also be used to develop a common dialing plan.

For numerical dialing, assume that some endpoint devices are connected to an H.323 gatekeeper infrastructure (440), while others are connected to a Microsoft OCS infrastructure (430). When an H.323-connected endpoint extracts the VMR address (e.g., 75333) from the meeting invitaion (in this embodiment), the H.323-connected endpoint simply needs to use 75333 as the destination address in the H.225 Setup message (as it normally does). This address can be resolved by the gatekeeper. The gatekeeper should be configured to route all VMR numbers to one or more appropriate bridges. For the OCS infrastructure, endpoints can set the SIP URI of the Request URI header with the phone number and a phone-context of the phone number in the user part of the SIP URI (as defined in RFC3966).

Again, a single number, or URI, can be inserted into a calendar invitation and the number, or URI, can be extracted by equipment running under different protocols and used to dial into the same conference. Thus video conferencing devices running under different protocols in the same environment can be used to join the same meetings. Users do not need to be aware that their equipment is using different protocols and video conferencing infrastructures can be easily migrated from one protocol to another over time. For example, instead of being required to upgrade all older H.323-based equipment to SIP based equipment, a company can start deploying SIP for new equipment and keep using older H.323 equipment and infrastructure, yet their users will easily be able to join the same video conferences.

In one embodiment of a Video Calendaring system according to this disclosure, each participant (meeting invitee) or host in a video meeting (e.g., either a video conferencing system or a virtual meeting room) may be closely coupled to a Calendar system (e.g., Exchange) mailbox. Two types of mailboxes may be defined: 1) personal mailboxes which typically belong to a person, and 2) resource mailboxes which can belong to a room or a piece of equipment etc. In one embodiment of Video Calendaring, the video conferencing system or VMR contains an Exchange client which performs actions on behalf of the mailbox to which it is coupled. Additionally, there are two example modes in which a video system's Exchange client can operate:
Associated Mode: this mode can enable a video system to be associated with a conference room resource mailbox or personal user mailbox. This mode is typically used for a video conferencing endpoint which joins meetings but does not host calendared meetings. In this mode, the video system's Exchange client can monitor the calendar and meeting requests for its associated Exchange mailbox account. The video system's calendaring software client application may not accept or decline meeting invitations because that function will be performed by the “owner” of the associated mailbox through normal Outlook/Exchange functionality. In this mode, when the time of a scheduled meeting arrives, the video conferencing systems calendaring software application client can extract the video number of the host VMR and dial into the meeting. Conference room video calendaring systems can be associated with a conference room resource mailbox and personal video conferencing systems can be associated with a personal mailbox.
Supervisor Mode: this mode is appropriate for the host of a video meeting (such as a VMR). In this mode, the video conferencing system video calendar interface client application can process meeting requests and accept/decline meeting requests based on its availability. This mode may be appropriate when resources are to be allocated (i.e., scheduled) when meetings are calendared. The accept/decline decision can be based on actual availability of resources.

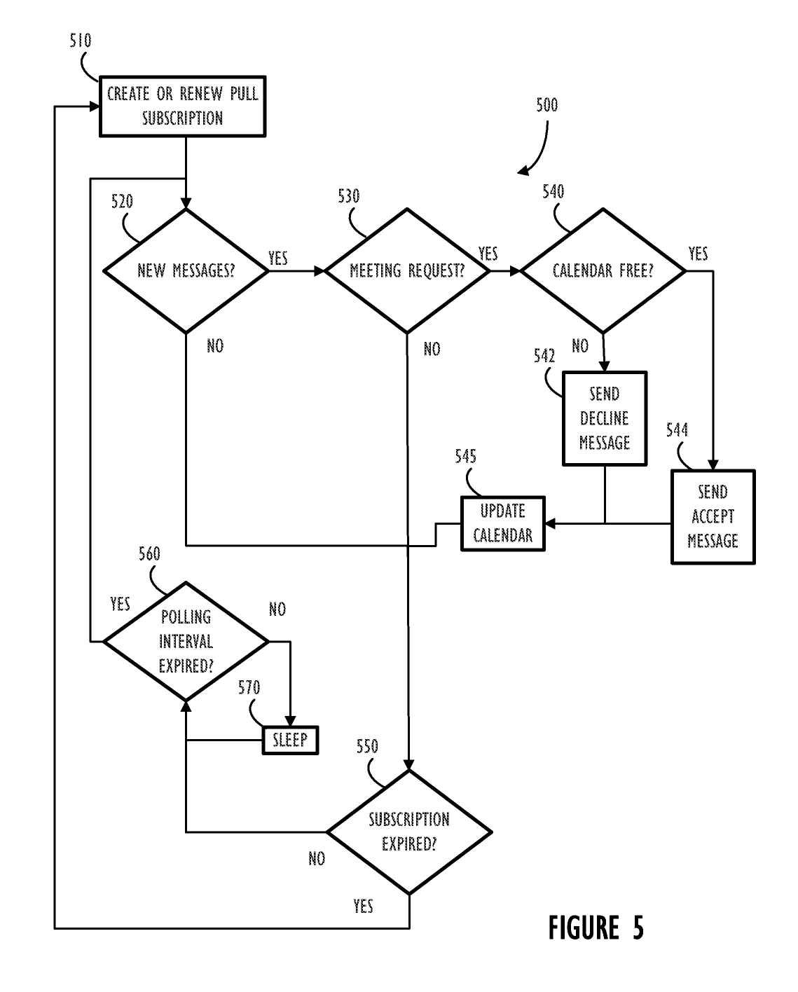

Referring now to FIG. 5, one manner in which a main message processing loop in which the video conferencing calendaring software (e.g., Exchange/Notes) client application can operate when running in supervisor mode is shown in flow chart form 500. Beginning at block 510 a client can create a “pull subscription” with the Exchange/Notes server, which enables it to retrieve message events from Exchange/Notes. The subscription can last until expressly terminated or for a period of time (e.g., five minutes) and refresh periodically. At block 520 it is determined if new messages have arrived for this client. If so, (the YES prong of block 520) control passes to block 530 to determine if the message is a meeting request. These messages could be e-mails or meeting invitations. If no new messages have arrived (the NO prong of block 520) or the message is not a meeting request (the NO prong of block 530) control can continue through the loop to block 550 to check to see if the subscription has expired. Continuing at block 530, when a meeting request message is received (the YES prong of block 530) control flows to block 540 to check calendar status relative to the request. If the calendar is free for the request (the YES prong of block 540) an accept message can be sent at block 544. If the calendar indicates the requested time is not available (the NO prong of block 540) a decline message can be sent at block 542. In either case, control can continue to block 545 where an update to the calendar can be processed if it is required. Next, control flows to block 550 where subscription expiration can be checked. If the subscription has not expired (the NO prong of block 550) flow continues to blocks 560 and 570 where a loop can be executed a number of times to determine if the polling interval has expired before returning to block 520 to again check for new messages. When the subscription has expired (the YES prong of block 550) control can return to block 510 to create or renew a pull subscription.

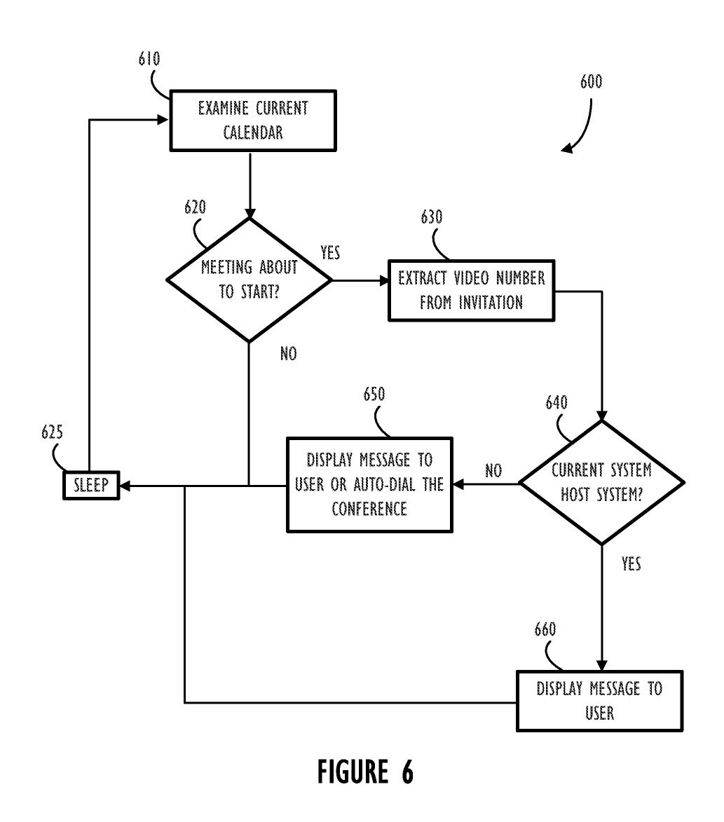

Referring now to FIG. 6, one example of a main calendar processing loop as performed by the video conferencing system Exchange/Notes client is shown in flow chart 600. In general, the client monitors its calendar and when the start time for a meeting that the video conferencing system is participating in is near, it takes action. Beginning at block 610, a client application examines the current calendar. At block 620 a determination is made as to if a meeting is about to start. If a meeting is not about to start (the NO prong of block 620) the client can sleep at block 625 before returning to block 610. However, if a meeting is about to start (the YES prong of block 620) the client can extract the conference information (e.g., video number) (block 630) from the invitaion as stored in the calendar. At block 640, it can be determined if the current client is executing on a conferencing device scheduled to host the meeting. If so (the YES prong of block 640) a message so indicating can be displayed to the user (block 660). If not (the NO prong of block 640) the client application can either display a message to the user or automatically dial into the scheduled conference (block 650). In either case the client can then sleep at block 625 prior to repeating the processing loop. Recall, the video number for the system or meeting room hosting the meeting can be embedded in the invitation or available from a server maintaining electronic calendars. Therefore, the video conferencing system client may:
display the meeting and video dialing information to the user; or
automatically dial in to the meeting, or enable the user to easily dial into a meeting by clicking a “join” button.

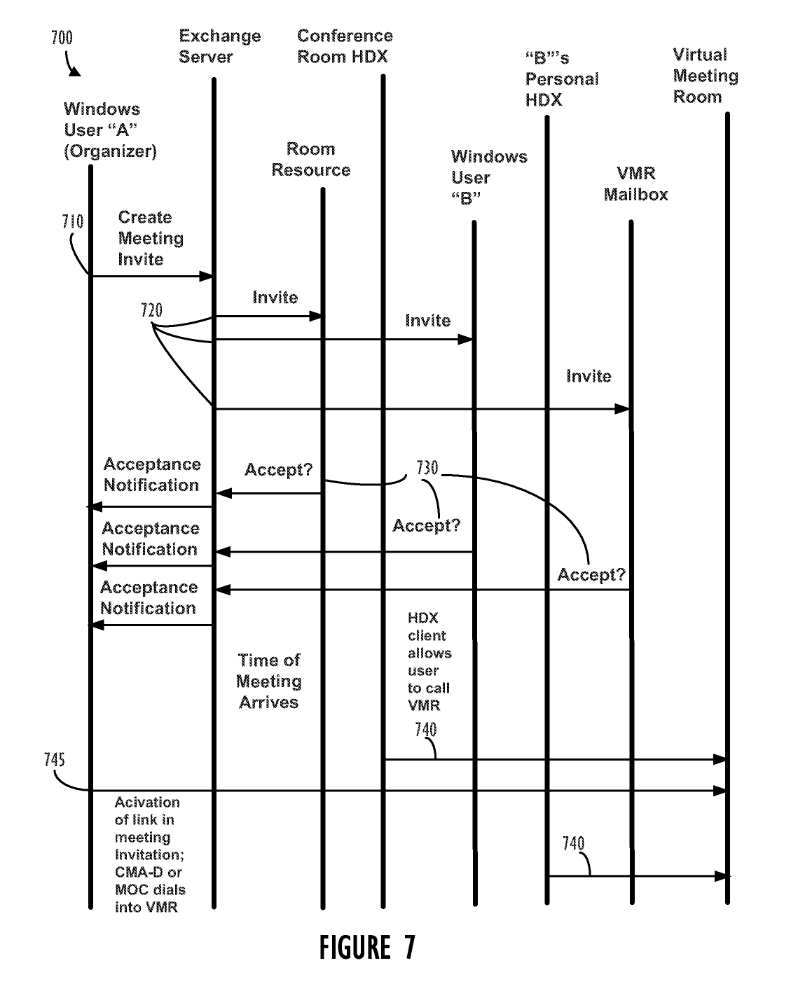

Referring now to FIG. 7, timeline 700 depicts a possible usage of one embodiment of this disclosure. In this example, a video meeting is planned for hosting in a Virtual Meeting Room on a bridge and all video equipment is running on a H.323 gatekeeper infrastructure. In this scenario, a meeting organizer (User A) can organize a meeting with a conference room and User B on a personal video conferencing device (e.g., HDX). At time 710 User A creates a meeting invite. Because the invite includes a plurality of participants separate invite messages are generated 720. Each of the individual invite messages can be processed by a client configured according to a disclosed embodiment and generate a response 730 indicating acceptance of the meeting. Then, when the time of the meeting arrives User A can activate the meeting by selecting a link in the original invitation 745. Also, the conferencing room HDX and User B's personal HDX can call into the meeting as indicated by lines 740. Additionally meeting participants that are not colocated with a conferencing system may access their calendar, for example from a smart phone, and join the meeting remotely.

To support the scenario of timeline 700, the bridge supporting the VMRs may run an Exchange client which is “associated” with a mailbox which has been configured in Exchange specifically for supporting VMRs. This means that the VMR Exchange client can be aware of the calendar schedule for all of the meetings on the bridge.

When a meeting organizer decides to include video conferencing in his meeting, the Outlook add-in can automatically insert the user's VMR video number into the message body of the invitation. The meeting invitation can also include a “callto” link to the VMR host. The meeting organizer can also choose to record the meeting by checking a box, and that information can also be inserted into the invitation. If the meeting is being recorded, the VMR can automatically connect to the recording device.

When an organizer schedules a meeting using video, the following information can be inserted into the meeting invitation by an Outlook add-in:
1. The video address of the VMR which is hosting the meeting.
2. The phone number of the VMR if the meeting is being hosted in a VMR.
3. Information indicating that the meeting is to be recorded. This information may consist of one or more Universal Resource Locators (URLs) associated with information recorded or otherwise made available before, during or after the meeting.

Exchange Server can be provisioned with at least one mailbox for VMRs. It is this mailbox that the Outlook add-in can add to the participant list when a meeting is scheduled for a VMR. This is also the mailbox whose calendar the VMR Exchange client can monitor. Note that more than one VMR mailbox can be provisioned. The Outlook add-in should add the VMR mailbox to the participant list, so that the meeting can appear in the VMR mailbox calendar.

An automated mechanism can be used to provide this information. Each Exchange mailbox has, for example, fifteen custom read/write attributes. One, or more, of these attributes can be configured to contain the information for each user. A management application (e.g., Polycom Distributed Media Application (DMA)), can configure user mailboxes with this information. Because a user's VMR number is relatively static, the add-in may also store it in the PC's registry so that it can be available if the connection to Exchange is not available

Video conferencing endpoints may enable users to access the calendar for the device. In the case of a personal system, the system displays the user's calendar. In the case of a conference room device, the system displays the room's calendar (with possibly suppressed private information as described below). Icons may be used to designate that a meeting includes video conferencing.

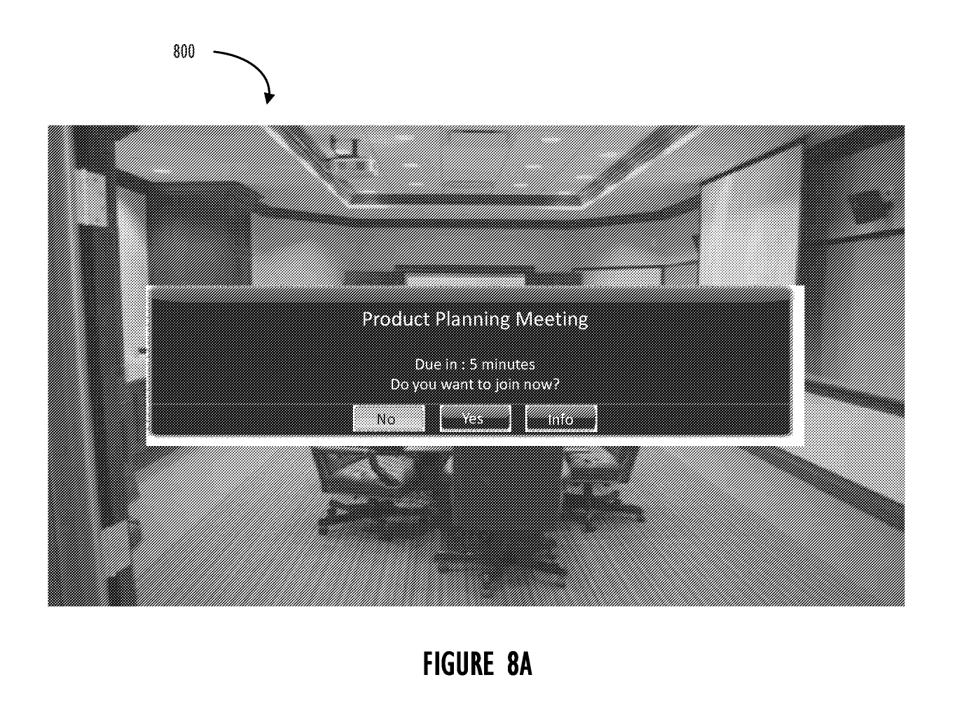

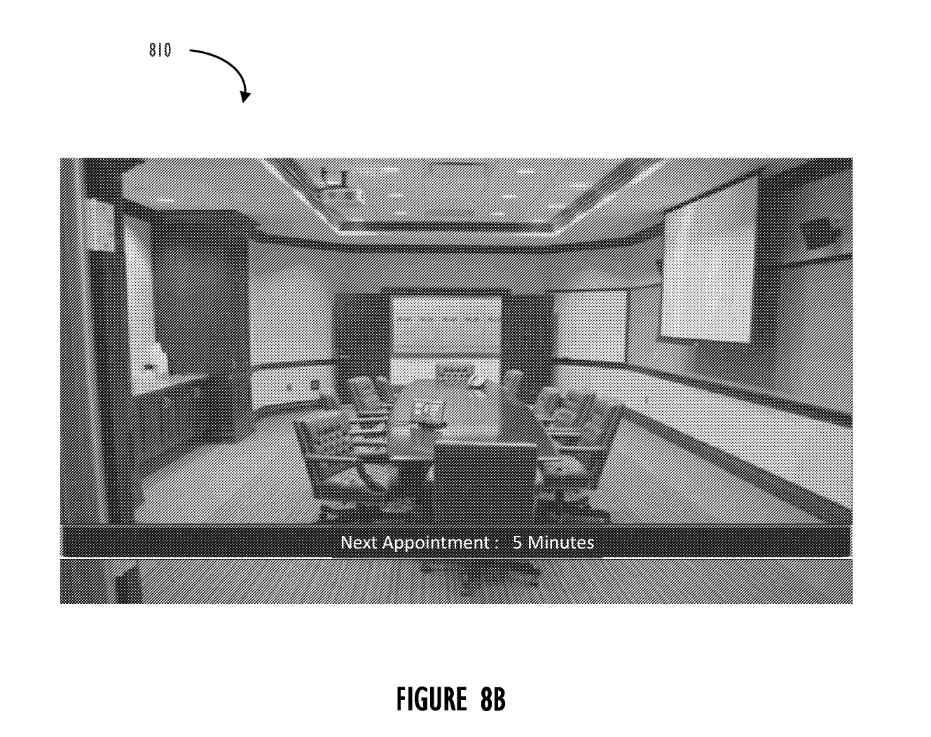

Video conferencing devices may also notify their users of upcoming meetings. If the video conferencing device is not in use, the notification can take up most of the display as in FIG. 8A, screen shot 800, so that it may be very apparent to users in the conference room. If the system is in use, the notification may be less obtrusive (as shown in FIG. 8B screen shot 810) so that it does not disrupt an ongoing meeting.

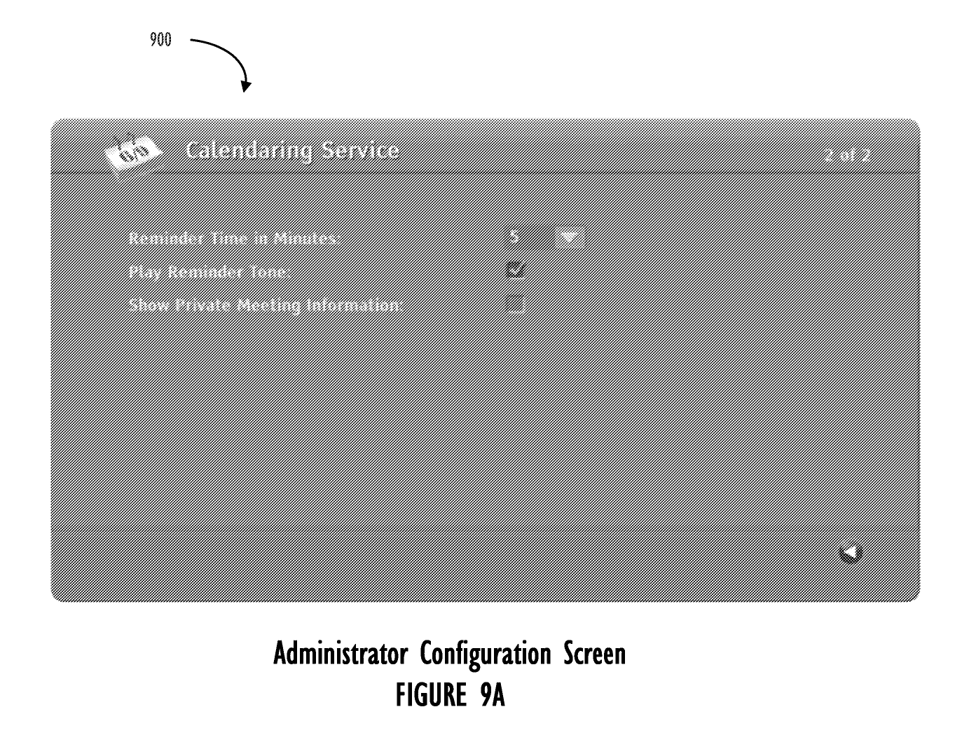

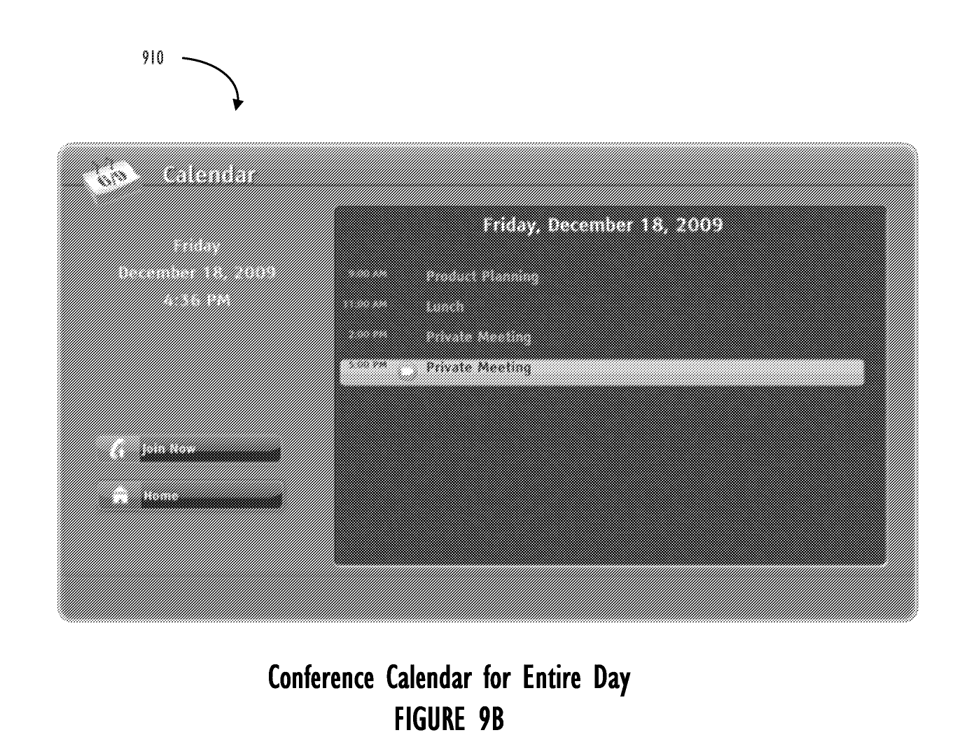

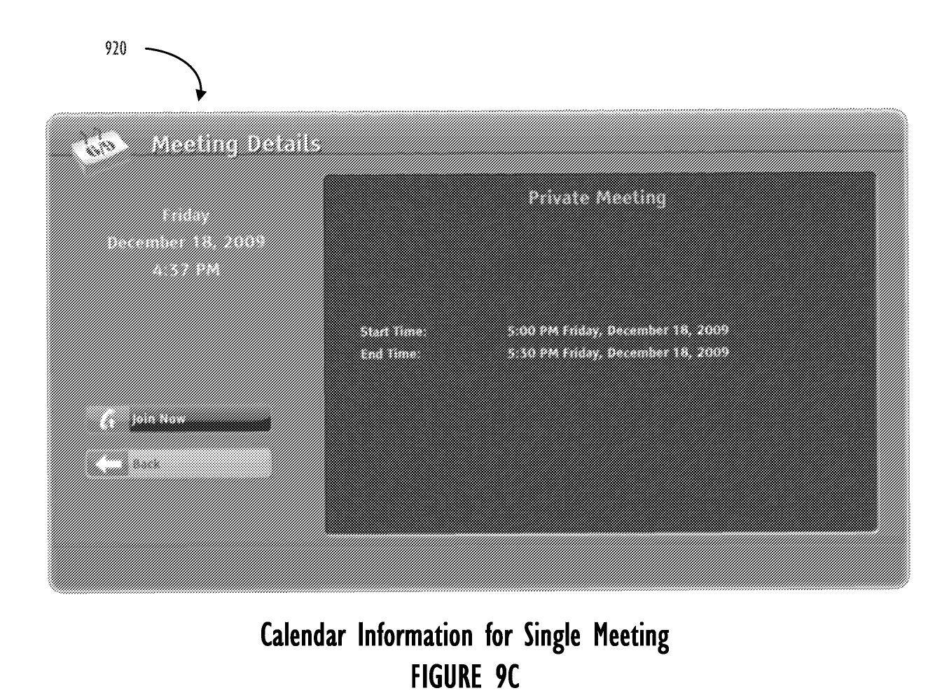

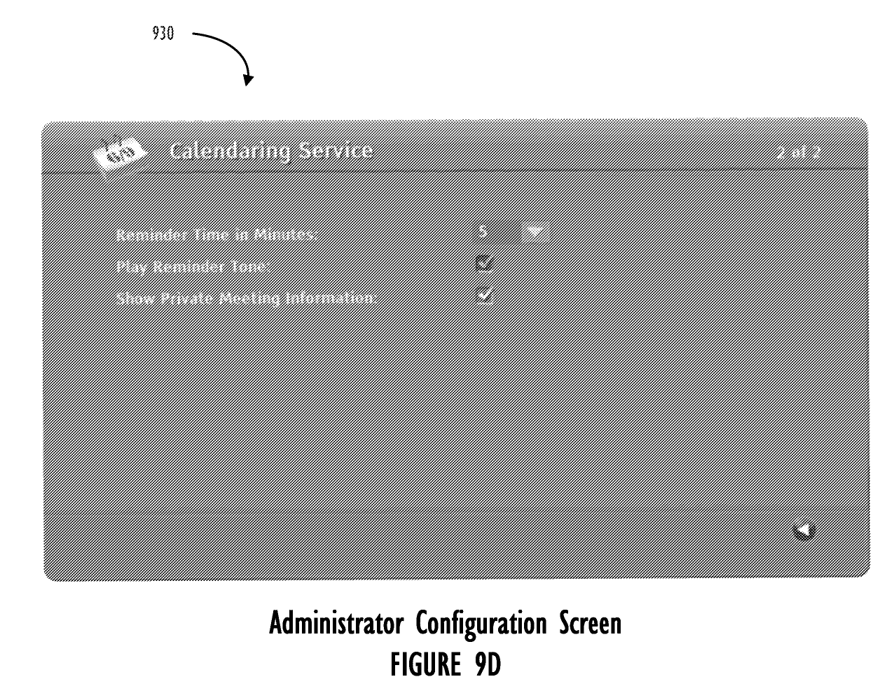

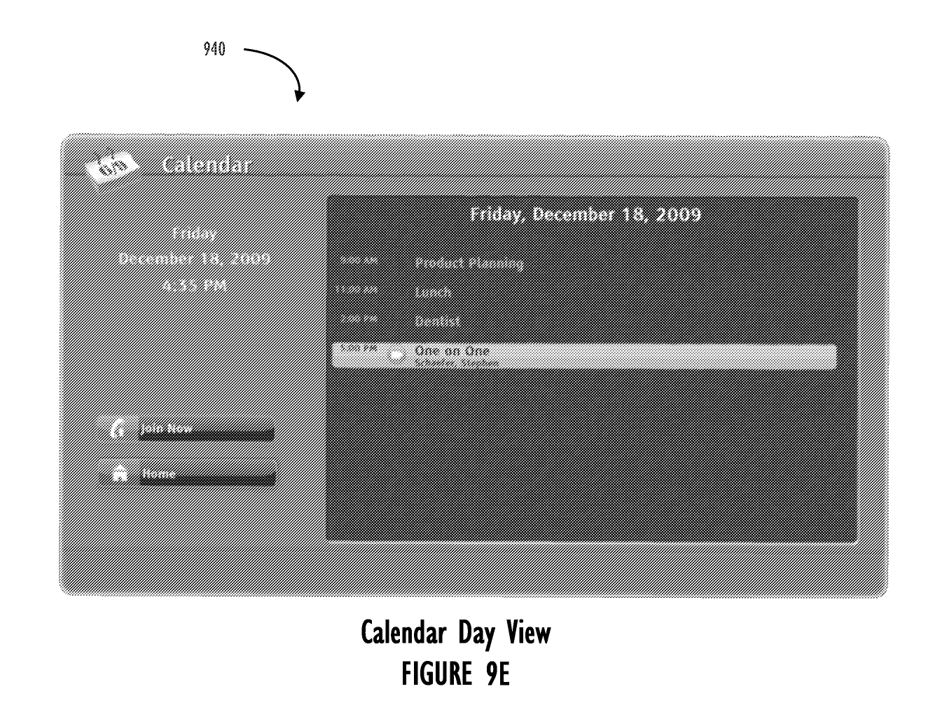

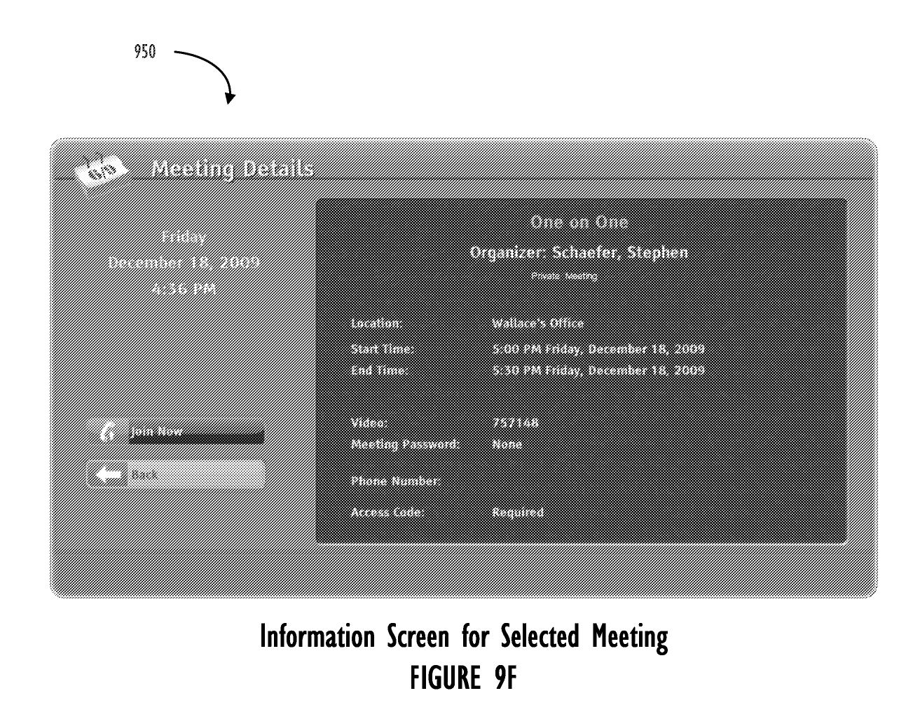

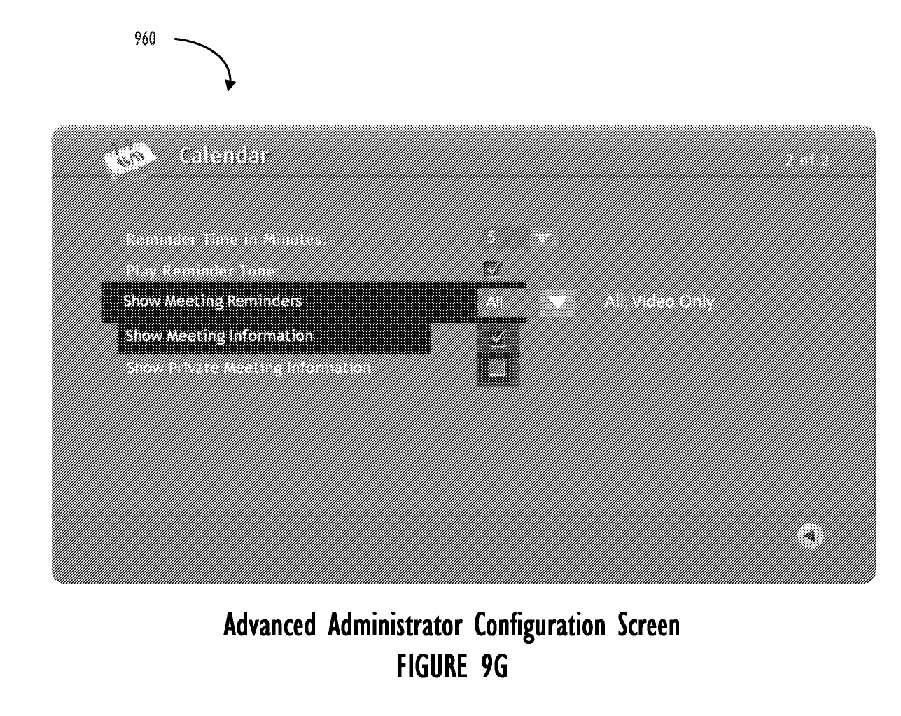

Referring now to FIGS. 9A-G which show screen shots (900-960) of one embodiment where “private” meeting information can be suppressed from display on a shared resource according to one embodiment of this disclosure. Screen shot 900 (FIG. 9A) shows a “Show Private Meeting Information” selection box on a conference system administration screen. This selection box allows a system administrator to identify whether private information should or should not be shown or obtainable from a shared resource. The intent being to prevent private information from being accessible by people who are not invited to the meeting. Screen shot 910 (FIG. 9B) shows an example screen shot of how minimal information might be shown (in a full day view) for shared resources. Screen shot 920 (FIG. 9C) shows more detailed information pertaining to a single entry from the full day view. Note, only enough information for users to know the duration of a private meeting in a public resource can be shown. In this manner other meeting organizers may be able to more easily plan their meetings. Screen shot 930 (FIG. 9D) shows substantially the same screen as FIG. 9A with a different option selected. In this case, a system administrator has chosen that private meeting information may be shown at least in part or all of the private meeting information is to be displayed or available from shared resources configured in this manner. Any number of options may be provided to the meeting organizer to allow for displaying selected pieces of information pertaining to a private meeting (e.g., NO meeting details; SOME meeting details, such as, showing subject of “private meeting;” or ALL meeting details and subject). Screen shot 940 (FIG. 9E) shows a daily view where the subject is not suppressed from shared resources (i.e., system configured as shown in 930). Screen shot 950 (FIG. 9F) shows details of a selected private meeting where meeting detail information is not suppressed. Finally, Screen shot 960 (FIG. 9G) shows an advanced configuration screen where an organizer has selected options to show meeting details and subjects and to show private meeting information as “private meeting.” Additionally, the resource configured as in 960 may mark meeting invitations as “private” even if the meeting organizer has not marked the actual meeting invitation as private. This last example may be useful for a conferencing resource in a public lobby of a corporation.

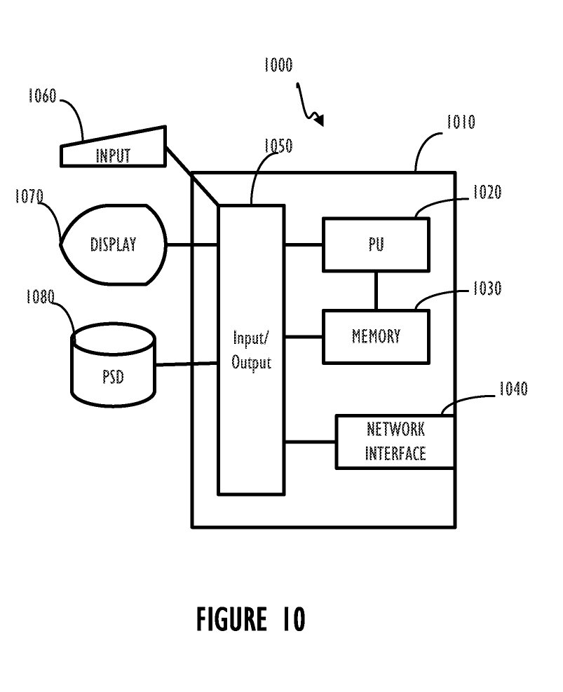

Referring now to FIG. 10, an example conferencing device 1000 is shown. Example conferencing device 1000 comprises a programmable control device 1010 which may be optionally connected to input 1060 (e.g., keyboard, mouse, touch screen, etc.), display 1070 or program storage device (PSD) 1080. Also, included with program control device 1010 is a network interface 1040 for communication via a network with other conferencing and corporate infrastructure devices (not shown). Note network interface 1040 may be included within programmable control device 1010 or be external to programmable control device 1010. In either case, programmable control device 1010 will be communicatively coupled to network interface 1040. Also note program storage unit 1080 represents any form of non-volatile storage including, but not limited to, all forms of optical and magnetic storage elements including solid-state storage. Examples of conferencing device 1000 include but are not limited to, personal computers, video conferencing endpoints, video conferencing data recorders, and MCUs.

Program control device 1010 may be included in a conferencing device and be programmed to perform methods in accordance with this disclosure (e.g., those illustrated in FIGS. 2, 5 and 6). Program control device 1010 comprises a processor unit (PU) 1020, input-output (I/O) interface 1050 and memory 1030. Processing unit 1010 may include any programmable controller device including, for example, the Intel Core®, Pentium® and Celeron® processor families from Intel and the Cortex and ARM processor families from ARM. (INTEL CORE, PENTIUM and CELERON are registered trademarks of the Intel Corporation. CORTEX is a registered trademark of the ARM Limited Corporation. ARM is a registered trademark of the ARM Limited Company.) Memory 1030 may include one or more memory modules and comprise random access memory (RAM), read only memory (ROM), programmable read only memory (PROM), programmable read-write memory, and solid state memory. One of ordinary skill in the art will also recognize that PU 1020 may also include some internal memory including, for example, cache memory.

Aspects of the invention are described as a method of control or manipulation of data, and may be implemented in one or a combination of hardware, firmware, and software. Embodiments of the invention may also be implemented as instructions stored on a machine-readable medium, which may be read and executed by at least one processor to perform the operations described herein. A machine-readable medium may include any mechanism for tangibly embodying information in a form readable by a machine (e.g., a computer). For example, a machine-readable medium (sometimes referred to as a program storage device or a computer readable medium) may include read-only memory (ROM), random-access memory (RAM), magnetic disc storage media, optical storage media, flash-memory devices, electrical, optical, and others.

Various changes in the details of the illustrated operational methods are possible without departing from the scope of the following claims. For instance, illustrative flow chart steps of FIGS. 2, 5 and 6 may be performed in an order different from that disclosed here. Alternatively, some embodiments may combine the activities described herein as being separate steps. Similarly, one or more of the described steps may be omitted, depending upon the specific operational environment the method is being implemented in. In addition, acts in accordance with FIGS. 2, 5 and 6 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices, sometimes called computer readable medium, suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method of interfacing one or more conferencing devices with meeting scheduling software, the method comprising:
executing on the one or more conferencing devices an interface to meeting scheduling software;
receiving at a first of the one or more conferencing devices a request for resources to support a conference;
determining, by the interface installed on the first conferencing device, availability of the first conferencing device; and
initiating a response to a server managing the meeting scheduling software wherein the response indicates availability of the first conferencing device.

2. The method of claim 1 wherein the request for resources comprises a meeting invitation request.

3. The method of claim 2 wherein the meeting invitation request comprises parameters associated with connecting devices at the time indicated in the meeting invitation.

4. The method of claim 2 wherein the response indicates acceptance of the meeting invitation.

5. The method of claim 2 wherein the response indicates the meeting invitation is declined.

6. The method of claim 1 wherein the request for resources comprises an update to a previously scheduled meeting and a further determination is made to check availability based on the updated request prior to initiating the response.

7. The method of claim 2 wherein the meeting invitation request comprises connection information for more than one signaling protocol.

8. The method of claim 7 wherein the more than one signaling protocol comprise session initiation protocol (SIP) and H.323.

9. The method of claim 2 wherein the meeting invitation request comprises connection information for a plurality of different types of devices.

10. The method of claim 9 wherein the plurality of different devices comprise devices supporting conference types selected from the group of conference types consisting of web conference, whiteboard conference, video conference and audio conference.

11. The method of claim 2 wherein the meeting invitation comprises information designated as private information.

12. The method of claim 1 wherein determining availability of the first conferencing device further comprises checking a calendar associated with a physical location of the first conferencing device.

13. The method of claim 1 wherein determining availability of the first conferencing device further comprises checking a calendar associated with an individual associated with the first conferencing device.

14. A method of interfacing one or more conferencing devices with meeting scheduling software, the method comprising:
executing on the one or more conferencing devices an interface to meeting scheduling software;
checking, by the interface of a first of the one or more conferencing devices, if a conference meeting is scheduled for the first conferencing device; and
initiating a connection by the first conferencing device to the conference meeting when the check determines a scheduled meeting is about to begin.

15. The method of claim 14 wherein initiating a connection comprises displaying an indication to a user for confirmation prior to the first conferencing device connecting to the conference.

16. The method of claim 15 wherein the indication displayed to a user is displayed in an unobtrusive fashion if the first conferencing device is currently connected to a different conference.

17. The method of claim 14 wherein the interface executing on the first conferencing device further determines if the first conferencing device is identified to host the scheduled meeting and, if so, automatically initiating the conference meeting.

18. The method of claim 17 wherein the first conferencing device is a multipoint control unit (MCU).

19. The method of claim 14 wherein initiating a connection comprises automatically initiating a connection at the scheduled time by the first conferencing device when the conferencing device is not currently connected to a different conference.

20. The method of claim 19 wherein automatically initiating a connection comprises dialing into a meeting using information extracted from a calendar entry associated with the scheduled meeting.

21. A method of controlling private information on a publically accessible conferencing device, the method comprising:
executing on the publically accessible conferencing device an interface to meeting scheduling software;
checking, by the interface of the publically accessible conferencing device, if a conference meeting is scheduled for the publically accessible conferencing device; and
suppressing display of any information identified as private in meeting scheduling information available to the publically accessible conferencing device.

22. A conferencing device comprising:
a programmable control device wherein the programmable control device is configured to:
receive a request for resources to support a conference;
determine availability of the conferencing device by interfacing with a meeting scheduling software server;
initiate a response to the meeting scheduling software server, the response indicating availability of the first conferencing device.

23. A conferencing device comprising:
a programmable control device wherein the programmable control device is configured to:
execute an interface to meeting scheduling software;
check, by the interface, if a conference meeting is scheduled for the conferencing device; and
initiate a connection by the conferencing device to the conference meeting when the check determines a scheduled meeting is ready to begin.

24. The conferencing device of claim 23 wherein the programmable control device is further configured to initiate display of a non-obtrusive indication of a future scheduled conference of the conferencing device when the conferencing device is actively participating in a conference other than the future scheduled conference.

25. A commonly accessible shared conferencing device comprising:
a programmable control device wherein the programmable control device is configured to:
execute an interface to meeting scheduling software;
check, by the interface, if a conference meeting is scheduled for the commonly accessible shared conferencing device; and
suppress display of any information identified as private in meeting scheduling information available to the commonly accessible shared conferencing device.

26. A program storage device comprising instructions stored thereon to cause a programmable control device to perform the method of claim 1.

27. A program storage device comprising instructions stored thereon to cause a programmable control device to perform the method of claim 14.

28. A program storage device comprising instructions stored thereon to cause a programmable control device to perform the method of claim 21.
